(19) United States
(12) Patent Application Publication
(10) Pub. No.: US 2008/0288955 A1
(43) Pub. Date: Nov. 20, 2008

(54) Method and System for Managing Preferences in a Client Portlet Container

(76) Inventors: Brandon J Brockway, Leander, TX (US); Rahul S. Kurane, Austin, TX (US); Bao Quoc Phan, Round Rock, TX (US); Mark William Talbot, Austin, TX (US)

Correspondence Address: IBM CORP (YA);C/O YEE & ASSOCIATES PC, P.O. BOX 802333, DALLAS, TX, 75380, US

(21) Appl. No.: 11/747,949

(22) Filed: May 14, 2007

(51) Int. Cl. G06F 9/44

(52) U.S. Cl. 719/311

(57) ABSTRACT

A system for managing preferences in a portlet container. In response to receiving remote preferences for a portlet, the remote preferences are merged with default preferences for the portlet to form a preference set for the portlet. In response to receiving user preferences for the portlet, the user preferences are merged with the preference set to form an effective preference set for the portlet. The portlet is manipulated according to the effective preference set to form a manipulated portlet. Then, the manipulated portlet is rendered.

### BACKGROUND OF THE INVENTION

1. Field of the Invention

The present invention relates generally to an improved data processing system. More specifically, the present invention is directed to a computer implemented method, system, and computer usable program code for managing a set of portlet preferences in a local client portlet container.

2. Description of the Related Art

Today, most computers are connected to some type of network. A network allows a computer to share information with other computer systems. The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. One set of protocols used on the Internet is called transmission control protocol/Internet Protocol (TCP/IP).

The Internet has revolutionized communications and commerce, as well as, being a source of both information and entertainment. To transfer information or data over the Internet, the World Wide Web environment is used. In this Web environment, servers and clients effect data transaction using the hypertext transfer protocol (HTTP). HTTP is a known protocol for handling the transfer of various data files, such as text files, graphic images, animation files, audio files, and video files.

With respect to obtaining information on the Internet, portal based user interfaces are becoming increasingly popular. These portal based user interfaces are known as portlets or portlet windows. Portlets are an encapsulation of content and functionality used to present information to users on the Internet. Portlets are reusable components that combine Web-based content, application functionality, and access to resources. Portlets are assembled into portal pages that, in turn, make up a portal implementation.

Conventionally, a portal server hosts a web application that is accessed by multiple clients. The portal server houses a portlet container, which provides an environment in which portlets may run. Typically, a portal server provides a system administrator with the ability to manage functions, such as default preferences and access privileges, for a specific portlet.

In some scenarios it is necessary to push server functionality as far out to the edge of the network as possible. In environments where a slow and unreliable network is present, it is not uncommon to move the entire portlet container from the server down to the client. In such an environment, there is a desire to lower the total cost of ownership (TCO) by centralizing, as much as possible, the administration and management of client-side components, such as plug-in files and preferences. This desire for centralization of administration and management is especially true in a distributed branch environment, such as retail stores and banks. Centralization of administration and management is a TCO savings strategy that is being adopted by a large number of businesses in various industries.

Therefore, it would be beneficial to have an improved computer implemented method, system, and computer usable program code for managing preferences in a client portlet container.

### SUMMARY OF THE INVENTION

Illustrative embodiments provide a computer implemented method, system, and computer usable program code for managing preferences in a client portlet container. In response to receiving remote preferences for a portlet, the remote preferences are merged with default preferences for the portlet to form a preference set for the portlet. In response to receiving user preferences for the portlet, the user preferences are merged with the preference set to form an effective preference set for the portlet. The portlet is manipulated according to the effective preference set to form a manipulated portlet. Then, the manipulated portlet is rendered.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a distributed data processing system in accordance with an illustrative embodiment;

FIG. 4 is an exemplary illustration of a portlet preference key value pair in accordance with an illustrative embodiment;

FIG. 5 is a flowchart illustrating an exemplary process for managing preferences in a client portlet container in accordance with an illustrative embodiment; and

FIG. 6 is a flowchart illustrating an exemplary process for managing portlet preferences in a portal server in accordance with an illustrative embodiment.

### DETAILED DESCRIPTION OF THE PREFERRED EMBODIMENT

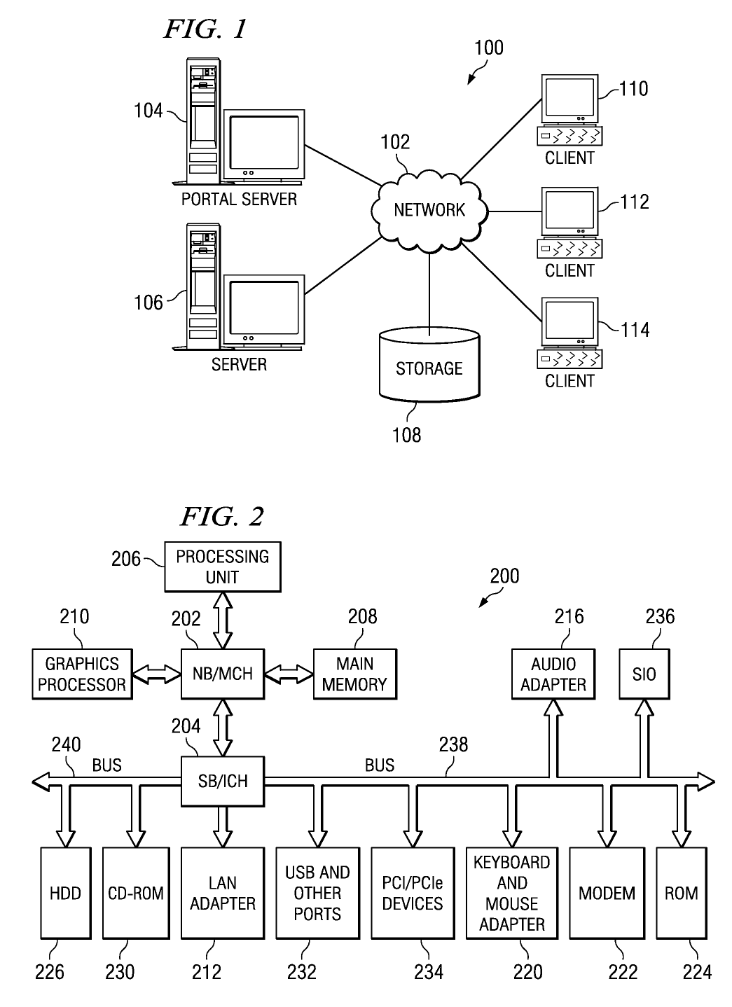

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between computers and other various devices connected together within network data processing system 100. Network 102 may include connections, such as wire, wireless communication links, or fiber optic cables.

In the depicted example, portal server 104 and server 106 connect to network 102, along with storage unit 108. In addition, clients 110, 112, and 114 also connect to network 102. Clients 110, 112, and 114 may, for example, be personal computers or network computers. In the depicted example, portal server 104 provides data, such as boot files, operating system images, applications, and portlets to clients 110, 112, and 114. Clients 110, 112, and 114 are clients to server 104 in this example. Storage 108 may, for example, be a database that stores a plurality of portlets and portlet preferences. Further, network data processing system 100 also may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as portal server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to NB/MCH 202. Processing unit 206 may contain one or more processors and may even be implemented using one or more heterogeneous processor systems. Graphics processor 210 may be coupled to NB/MCH 202 through an accelerated graphics port (AGP), for example.

In the depicted example, local area network (LAN) adapter 212 is coupled to SB/ICH 204 and audio adapter 216, keyboard and mouse adapter 220, modem 222, read only memory (ROM) 224, universal serial bus (USB) and other ports 232, and PCI/PCIe devices 234 are coupled to SB/ICH 204 through bus 238, and hard disk drive (HDD) 226 and CD-ROM 230 are coupled to SB/ICH 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). HDD 226 and CD-ROM 230 may, for example, use an integrated drive electronics (IDE) or serial advanced technology attachment (SATA) interface. A super I/O (SIO) device 236 may be coupled to SB/ICH 204.

An operating system runs on processing unit 206 and coordinates and provides control of various components within data processing system 200 in FIG. 2. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as HDD 226, and may be loaded into main memory 208 for execution by processing unit 206. The processes of the illustrative embodiments may be performed by processing unit 206 using computer implemented instructions, which may be located in a memory such as, for example, main memory 208, ROM 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in NB/MCH 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Illustrative embodiments provide a computer implemented method, system, and computer usable program code for managing preferences in a client portlet container. In response to receiving remote preferences for a portlet, the portlet container merges the remote preferences with default preferences for the portlet to form a current preference set for the portlet. A system administrator specifies the remote preferences and a portlet developer specifies the default preferences. However, it should be noted that the default preferences also may be specified by roles other than that of the portlet developer.

In response to receiving user preferences for the portlet, the portlet container merges the user preferences with the current preference set to form an effective preference set for the portlet. Then, the portlet container manipulates the portlet according to the effective preference set. Afterward, the portlet container renders the manipulated portlet in a display for a user.

In an illustrative embodiment, each client device in the network includes a portlet container. In this type of topology, illustrative embodiments may map multiple portlet containers to a single user. Also, in this environment the portal server manages each of the network clients. The portal server administrator determines which portlets to install on the locally run client portlet container, which is “inside” of a client application.

The client portlet container may operate without connecting to the portal server. As a result, the portlet container caches remote preferences that the system administrator sends on a predetermined time basis down to the client device. In addition, the portlet container caches locally modified user preferences. Also, if the portal server is not available when a portlet is initialized, then the portlet container may use default preferences (i.e. those preferences specified in the portlet descriptor) to render the portlet.

Illustrative embodiments use three types of preferences: default preferences, remote preferences, and user preferences. Default preferences are specified by the portlet developer in the portlet descriptor, such as, for example, portlet.xml. The default preferences may be declaratively specified in a local application that hosts the client portlet container. In other words, the portlet developer may locally specify the default preferences. However, default preferences may be modified by a system administrator at the portal server after deployment of the portlet, which are known as remote preferences. Certain preferences, which are implementation dependent, may be modified by a user as the user interacts with a portlet at a client device, which are known as user preferences. A client portlet container uses a priority union algorithm, with the system administrator setting each preference set's priority level, to determine an effective preference set for a specific portlet at runtime.

A portlet has a two phase lifecycle. The first phase is an action phase and the second phase is a render phase. The action phase, for example, stores portlet preferences and adds parameters for rendering. The rendering phase displays the portlet.

At the end of the portlet action phase, the portlet container intercepts an action response. The portlet container parses user preference data from the action response and then locally stores the user preference data. In addition, after receiving remote preferences from the portal server, the portlet container locally stores the remote preferences. Then, the portlet container merges the user preferences from the action response with the remote preferences from the portal server using a merging process.

The portlet container locally stores these preferences as a preference set based on the context root, portlet name, and portlet window identifier of the portlet. In addition, the portlet container creates a key for each preference set based on the combination of the preference set's context root, portlet name, and portlet window identifier. The portlet container locally stores preference sets as key value pairs. If a preference set already locally exists for a portlet, the portlet container merges the existing preference set with the new preference set. Subsequently, the portlet container passes this new effective preference set to the portlet as the portlet is initialized to render the portlet according to the effective preference set.

Thus, illustrative embodiments provide a method for offloading portal server functionality to each client device. As a result, illustrative embodiments lower the TCO via the remote administration and management of client-side components.

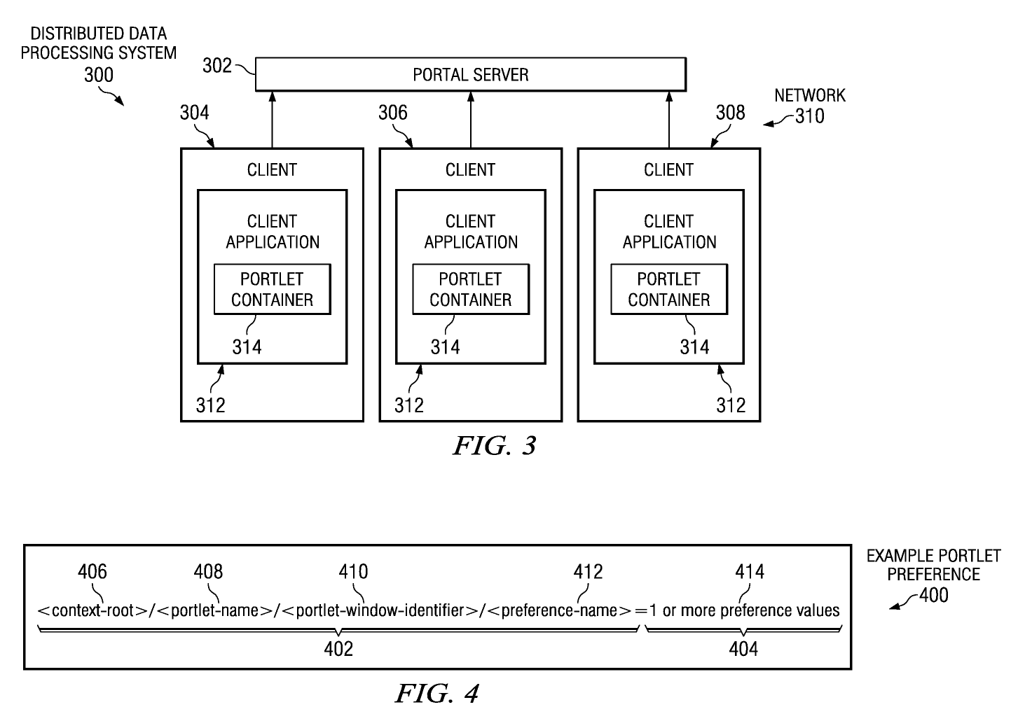

With reference now to FIG. 3, a block diagram of a distributed data processing system is depicted in accordance with an illustrative embodiment. Distributed data processing system 300 may, for example, be implemented in network data processing system 100 in FIG. 1. Distributed data processing system 300 includes portal server 302 and clients 304, 306, and 308, which are coupled together via network 310. For example, network data processing system 100 includes portal server 104 and clients 110, 112, and 114, which are connected together via network 102 in FIG. 1.

Portal server 302 is a server device that provides a plurality of portlets to a plurality of clients, such as clients 304, 306, and 308. A system administrator manages portal server 302 and deploys the plurality of portlets from portal server 302 to clients 304, 306, and 308 as necessary. Also, the system administrator determines which of the plurality of portlets are sent to each of the plurality of clients. In addition, the system administrator may specify remote preferences for one or more of the portlets sent to clients 304, 306, and 308. Portal server 302 sends these remote preferences to the respective client devices on a scheduled predetermined time basis or on demand by the system administrator.

Clients 304, 306, and 308 are clients to portal server 302. Clients 304, 306, and 308 include client application 312 and portlet container 314. Client application 312 is a software application designed to support portlet container 314. In other words, portlet container 314 is a thin layer on top of client application 312 and uses the functionality provided by client application 312. Portlet container 314 provides a runtime environment for the portlets received from portal server 302. This runtime environment allows a user to instantiate, manipulate, and render the portlets.

The system administrator may use an administrative console for portal server 302 to specify the remote preferences for the plurality of portlets. Portal server 302 deploys the specified remote preferences to clients 304, 306, and 308 via a network transport stream. After clients 304, 306, and 308 receive the network transport stream, a portlet action event is sent to portlet container 314. Portlet container 314 receives the portlet action event from client application 312. Then, portlet container 314 parses the network transport stream and creates a remote preference set for each portlet. Each context root, portlet name, and portlet window identifier combination maps to a unique preference set for a portlet.

After parsing the network transport stream, portlet container 314 caches the remote preferences locally and sets a flag, which is associated with the remote preferences. Portlet container 314 checks for this set flag every time a portlet is rendered. If the flag is set, portlet container 314 merges the current preference set in the local portlet container with the remote portlet preferences cached by client application 312.

The standard for portlets allows a portlet developer to define default preferences in the portlet definition. Consequently, when portlet container 314 receives remote preferences from portal server 302 a merge of portlet preferences is necessary. Also, it should be noted that the system administrator is not limited to the number of updates that may be made to the default preferences of a portlet. Each update of the default preferences sent from portal server 302 to clients 304, 306, and 308 require a preference merge.

Illustrative embodiments utilize a dual priority union or merge process. First, portlet container 314 performs a priority union of the remote preferences and the default preferences to form a preference set. Then, portlet container 314 performs a priority union of the current preference set with user preferences to form an effective preference set for the portlet.

A preference set is keyed to the key formed by the combination of the context root, portlet name, and portlet window identifier for each portlet. Illustrative embodiments utilize an algorithm that merges portlet preferences. An effective preference set is a set of default, remote, and user preferences, which portlet container 314 merges together using the priority union algorithm. Preferences contain a key and one or more preference values. Also, a preference may contain metadata about itself. For example, an illustrative embodiment may include in a preference a field that contains access permission as metadata.

As an illustration of the merging process, when merging, for example, preference sets “A” and “B”, preference set “A” has priority. Preference set “A” may, for example, represent remote preferences and preference set “B” may, for example, represent default preferences. Preference set “C” is the new resultant preference set formed by the merger of preference sets “A” and “B”. Preference set “C” may, for example, be the current preference set. Also, preference sets “A”, “B”, and “C” contain preferences “a”, “b”, and “c”, respectively. In this merging process of preference sets “A” and “B”, four scenarios may exist.

In the first scenario, preference “a” has a value and metadata defined. As a result, preference “b”'s value and metadata are ignored because preference “a” takes priority over preference “b”. Therefore, resultant preference “c” has the value of preference “a” and the metadata of preference “a”.

In the second scenario, preference “a” has a value, but no metadata defined. As a result, preference “b”'s value is ignored. Therefore, resultant preference “c” has the value of preference “a” and the metadata of preference “b”.

In the third scenario, preference “a” has no value, but does have metadata defined. As a result, preference “b”'s metadata is ignored. Therefore, resultant preference “c” has the value of preference “b” and the metadata of preference “a”.

In the final scenario, preference “a” has no value and no metadata defined. Therefore, resultant preference “c” has the value of preference “b” and the metadata of preference “b”.

After portlet container 314 merges preferences “a” and “b”, resultant preference set “C” becomes the new current preference set. If another remote preference update is received from portal server 302, the current preference set becomes the low priority preference set and the newly received remote preference update becomes the high priority preference set.

Afterward, illustrative embodiments perform another priority union. This subsequent priority union involves the merge of the current preference set with a locally stored user preference set. The merging process for this second priority union is similar to the merging process for the first priority union described above. To follow the example from above, the current preference set is equal to preference set “C”. The user preference set is equal to preference set “Y”. The resultant effective preference set, which is the result of merging current preference set “C” with user preference set “Y”, is effective preference set “Z”. In this second priority union, user preference set “Y” takes priority over current preference set “C”. However, it should be noted that the system administrator has total control of the merging process. In other words, the system administrator always has the option to change a preference set's priority level if the system administrator so desires.

With reference now to FIG. 4, an exemplary illustration of a portlet preference key value pair is depicted in accordance with an illustrative embodiment. Example portlet preference 400 is an example of a portlet preference key value pair. Illustrative embodiments store portlet preferences as string key value pairs. A key value pair combines a unique identification key for a portlet preference set with one or more preference values for the portlet.

Example portlet preference 400 includes key 402 and preference values 404 to comprise the key value pair. Key 402 includes context root 406, portlet name 408, portlet window identifier 410, and preference name 412. Preference name 412 is unique within its namespace, which is defined by the combination of context root 406, portlet name 408, and portlet window identifier 410. Preference values 404 include one or more preference values 414 for the portlet uniquely identified by key 402.

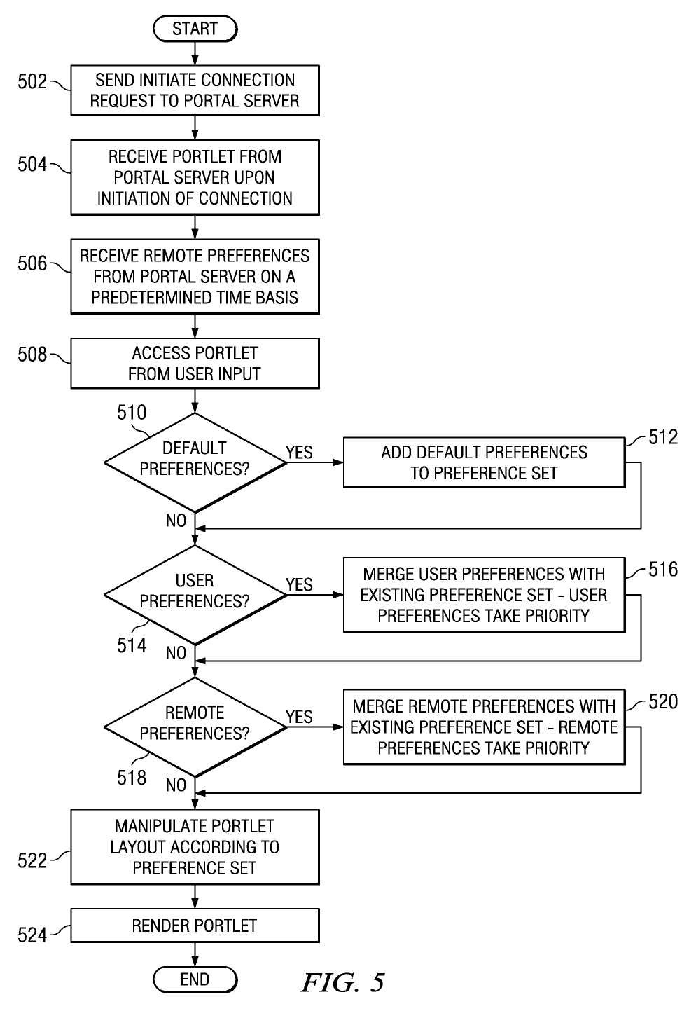

With reference now to FIG. 5, a flowchart illustrating an exemplary process for managing preferences in a client portlet container is shown in accordance with an illustrative embodiment. The process shown in FIG. 5 may be implemented in a portlet container, such as, for example, portlet container 314 in FIG. 3.

The process begins when a client device, such as, for example, client 304 in FIG. 3, sends an initiate connection request to a portal server, such as, for example, portal server 302 in FIG. 3 (step 502). After sending the initiate connection request in step 502, the client device utilizes the portlet container to receive one or more portlets from the portal server upon initiation of the connection with the portal server (step 504). In addition, the client portlet container receives remote preferences from the portal server on a predetermined time basis (step 506).

The remote preferences are portlet preferences that a system administrator specifies at the portal server for the one or more portlets sent to the client portlet container. Also, the predetermined time basis for sending the remote preferences from the portal server to the client device may, for example, be once an hour, day, week, or month. However, the system administrator may send the remote preferences to the client device on any predetermined time interval basis or on demand.

Then, a user using the client device accesses a portlet within the portlet container from the one or more portlets sent from the portal server (step 508). Subsequent to the user accessing the portlet in step 508, the portlet container makes a determination as to whether the portlet includes default preferences specified by a portlet developer (step 510). If the portlet does include default preferences, yes output of step 510, then the portlet container adds the default preferences to a preference set for the portlet (step 512). The preference set may include a merge of default preferences, remote preferences, and user preferences to comprise an effective preference set for the portlet. After adding the default preferences to the preference set in step 512, the process proceeds to step 514.

If the portlet does not include default preferences, no output of step 510, then the portlet container makes a determination as to whether the user modified or changed the preference set (step 514). If the user did modify the preference set, yes output of step 514, then the portlet container merges the user preferences with the existing preference set (step 516). It should be noted that user preferences take priority at this step of the process. Subsequent to merging the user preferences with the existing preference set in step 516, the process proceeds to step 518.

If the user did not modify the preference set, no output of step 514, then the portlet container makes a determination as to whether remote preferences have been received from the portal server (step 518). The system administrator may specify remote preferences as necessary. If remote preferences are received from the portal server, yes output of step 518, then the portlet container merges the remote preferences with the existing preference set (step 520). It should be noted that the remote preferences take priority at this step of the process. After merging the remote preferences with the existing preference set in step 520, the process proceeds to step 522.

If remote preferences are not received from the portal server, no output of step 518, then the portlet container manipulates the portlet layout according to the effective preference set (step 522). Then, the portlet container renders the portlet in a display of the client device for the user to view (step 524). The process terminates thereafter.

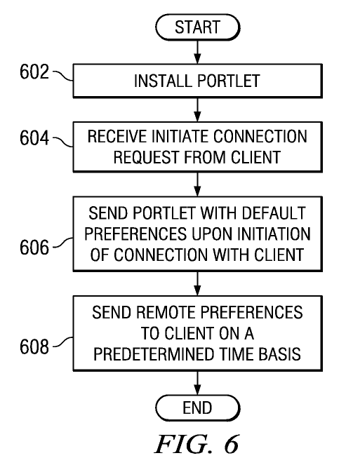

With reference now to FIG. 6, a flowchart illustrating an exemplary process for managing portlet preferences in a portal server is shown in accordance with an illustrative embodiment. The process shown in FIG. 6 may be implemented in a portal server, such as, for example, portal server 302 in FIG. 3.

The process begins when a system administrator installs a plurality of portlets in the portal server (step 602). In addition to installing the portlets in the portal server, the system administrator determines which of the plurality of portlets to deploy from the portal server to specific client devices, such as, for example, clients 304, 306, and 308 in FIG. 3. Further, the system administrator may specify remote preferences for any or all of the deployed portlets. Remote preferences are portlet preferences specified by the system administrator at the portal server. It should be noted that remote preferences take priority over default preferences specified by the portlet developer. Furthermore, the system administrator may specify whether the remote preferences take priority over user preferences or not. In other words, the system administrator always retains the ability to set priority levels for preferences.

Subsequent to the system administrator installing the portlets in the portal server in step 602, the portal server receives an initiate connection request from a client device (step 604). Afterward, the portal server sends the appropriate portlets, which are determined by the system administrator, along with any specified default preferences for those portlets, to the client device upon initiation of the connection with the client device (step 606). Moreover, the portal server sends remote preferences specified by the system administrator to the client device on a predetermined time basis for the previously sent portlets (step 608). The process terminates thereafter.

Thus, illustrative embodiments provide a computer implemented method, system, and computer usable program code for managing preferences in a portlet container. The invention may take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system. For the purposes of this description, a computer-usable or computer-readable medium may be any tangible apparatus that may contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a ROM, a rigid magnetic disk, and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, et cetera) may be coupled to the system either directly or through intervening I/O controllers.

Network adapters also may be coupled to the system to enable the data processing system to become coupled to other data processing systems, remote printers, or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing preferences in a portlet container, the computer implemented method comprising:
responsive to receiving remote preferences for a portlet, merging the remote preferences with default preferences for the portlet to form a preference set for the portlet;
responsive to receiving user preferences for the portlet, merging the user preferences with the preference set to form an effective preference set for the portlet;
manipulating the portlet according to the effective preference set to form a manipulated portlet; and
rendering the manipulated portlet.

2. The computer implemented method of claim 1, wherein the remote preferences take priority over the default preferences, and wherein the user preferences take priority over the remote preferences.

3. The computer implemented method of claim 1, wherein the portlet container performs the merging, manipulating, and rendering steps.

4. The computer implemented method of claim 1, wherein the portlet container is included in a plurality of client devices connected to a network, and wherein a portal server manages the plurality of client devices.

5. The computer implemented method of claim 4, wherein the portlet container operates without connecting to the portal server.

6. The computer implemented method of claim 1, wherein the portlet container locally caches the default preferences, the remote preferences, and the user preferences.

7. The computer implemented method of claim 4, wherein the portal server sends the remote preferences on a predetermined time basis.

8. The computer implemented method of claim 1, wherein the remote preferences are specified by a system administrator.

9. The computer implemented method of claim 8, wherein the system administrator sets a priority level for the remote preferences and user preferences.

10. The computer implemented method of claim 1, wherein the portlet container uses a dual priority union algorithm to perform the merging steps.

11. The computer implemented method of claim 1, wherein the portlet container intercepts the user preferences from a portlet action.

12. The computer implemented method of claim 1, wherein the portlet container stores preferences as a key value pair.

13. The computer implemented method of claim 12, wherein the key value pair includes a context root, a portlet name, a portlet window identifier, a preference name, and one or more preference values.

14. A data processing system for managing preferences in a portlet container, comprising:
a bus system;
a storage device connected to the bus system, wherein the storage device includes a set of instructions; and
a processing unit connected to the bus system, wherein the processing unit executes the set of instructions to merge remote preferences for a portlet with default preferences for the portlet to form a preference set for the portlet in response to receiving the remote preferences, merge user preferences for the portlet with the preference set to form an effective preference set for the portlet in response to receiving the user preferences, manipulate the portlet according to the effective preference set to form a manipulated portlet, and render the manipulated portlet.

15. The data processing system of claim 14, wherein the portlet container is included in a plurality of client devices connected to a network, and wherein a portal server manages the plurality of client devices.

16. A computer program product for managing preferences in a portlet container, the computer program product comprising:
a computer usable medium having computer usable program code embodied therein, the computer usable medium comprising:
computer usable program code configured to merge remote preferences for a portlet with default preferences for the portlet to form a preference set for the portlet in response to receiving the remote preferences;
computer usable program code configured to merge user preferences for the portlet with the preference set to form an effective preference set for the portlet in response to receiving the user preferences;
computer usable program code configured to manipulate the portlet according to the effective preference set to form a manipulated portlet; and
computer usable program code configured to render the manipulated portlet.

17. The computer program product of claim 16, wherein the portlet container uses a dual priority union algorithm to execute the computer usable program code configured to merge the remote preferences with the default preferences and the computer usable program code configured to merge the user preferences with the preference set.

18. The computer program product of claim 16, wherein the portlet container intercepts the user preferences from a portlet action.

19. The computer program product of claim 16, wherein the portlet container stores preferences as a key value pair.

20. The computer program product of claim 19, wherein the key value pair includes a context root, a portlet name, a portlet window identifier, a preference name, and one or more preference values.
